(19) United States
(12) Patent Application Publication
(10) Pub. No.: US 2019/0184513 A1
(43) Pub. Date: Jun. 20, 2019

(54) MACHINING DEVICE FOR MACHINING A WORKPIECE NARROW SIDE AND METHOD

(71) Applicant: HOMAG GmbH, Schopfloch (DE)

(72) Inventors: Wolfgang KNORR, Hoettingen (DE); Stephen WINNEY, Freudenstadt (DE)

(21) Appl. No.: 16/218,403

(22) Filed: Dec. 12, 2018

(30) Foreign Application Priority Data
Dec. 14, 2017 (DE) 102017129916.5

(51) Int. Cl. B23Q 39/04; B23Q 39/02

(52) U.S. Cl. CPC B23Q 39/048; B27M 1/08; B23Q 39/022

(57) ABSTRACT

The invention relates to a machining device for machining a narrow side of an, in particular plate-shaped workpiece. Such a machining device can particularly be used in the field of the furniture and component industry. Machining device has: a machining unit for machining a narrow side of a workpiece, a conveyor unit for moving the workpiece in a transport direction relative to the machining unit, a detection unit for detecting an optical and/or three-dimensional structure of the workpiece moved by means of the conveyor unit, and a holding unit for holding the workpiece at the conveyor unit at least between the position of the detection unit and the machining unit.

### TECHNICAL FIELD

The invention relates to a machining device for machining a narrow side of an, in particular plate-shaped, workpiece. In particular, such a type of machining device can be used in the field of the furniture and component industry.

### PRIOR ART

In the prior art, machining devices are known with which floor panels can be machined. The floor panels are thereby moved through a longitudinal profiling machine with which a profile (for example, a so-called click profile) is introduced into a narrow side of the workpiece.

For a high-quality machining and a corresponding machining result, it is essential in this context to take into account the relation of the narrow side to be machined with regard to an optical and/or three-dimensional structure on the main side of the workpiece. In order to ensure a constantly even quality, a reference edge is therefore firstly introduced to a narrow side of the workpiece which serves as a reference area for subsequent machining steps.

In DE 101 05 960 A1, a method for machining continuously moved workpieces is described, with the workpieces being aligned and being machined on the pass on a first side extending substantially parallel to the direction of movement as well as on a second side opposite to the first side, extending substantially parallel to the direction of movement, forming a reference edge on the pass. The workpieces are then subsequently moved transversely to the direction of movement, aligned to the reference edge of the second side and machined to size on the second side on the pass.

Even though with the machining device known from DE 101 05 960 A1, workpieces have a first and a second side which are aligned to each other dimensionally and angularly after the complete machining, there is the demand for aligning the reference edge even more exactly to the optical and/or three-dimensional structure of the main side of the workpiece.

### SUBJECT MATTER OF THE INVENTION

The invention aims to provide a device and a method with which the machining accuracy and thus the manufacturing quality can be further increased.

The invention provides a machining device according to claim 1 and a method according to claim 8, with which the aforementioned goal is achieved. Other preferred embodiments are stated in the dependent claims and explained in the following description of the invention.

One idea of the invention is to evaluate a moved workpiece in a clamped state by means of a detection unit and, on the basis of the information determined thereon, to move a machining unit in such a way that the reference edge to be created is positioned using an optical and/or three-dimensional structure. In this way, it is possible to align the reference edge exactly along the optical and/or three-dimensional structure.

The optical structure can thereby be a graphic design/decor on a main side of the workpiece. A three-dimensional structure is, for example, a recess extending along the main side or a profile extending along the main side. For example, such a recess or profile can be introduced into a raw panel by a press.

The invention provides a machining device intended in particular for machining plate-shaped workpieces. Such workpieces can be, for example, boards for furniture, floor panels, wall units, kitchen worktops or the like.

The machining device comprises a machining unit for machining a narrow side of a workpiece. Such a machining unit can be, for example, a milling cutter. The machining apparatus further comprises a conveyor unit for moving the workpiece in a transport direction relative to the machining unit, such as a belt conveyor.

The machining device according to the invention has a detection unit for detecting an optical and/or three-dimensional structure on the basis of the workpiece moved by the conveyor. Such a detection unit may be a camera, such as a CCD camera, with which it is possible to determine the optical appearance of the workpiece or a structure present on the workpiece in the area to be detected. The detection of the structure can thereby be carried out during a movement of the workpiece by means of the conveyor device.

Moreover, the machining device comprises a holding unit for holding the workpiece on the conveyor unit at least between the position of the detection unit and the machining unit. The holding unit enables a holding of the workpiece while it is being moved. It is preferred that the workpiece is clamped continuously, particularly by means of a top pressure belt, between the detection and the machining. Thus, the workpiece can be detected and machined in a clamped state.

Since the workpiece can be held with the aforementioned holding unit between the position of the detection unit and the machining device, the exact position of the optical and/or three-dimensional structure on the workpiece detected by the detection unit is the same as that at the machining location, since the workpiece does not have to be clamped again. Thus, there are no further influences that could change the position of the optical and/or three-dimensional structure. If the workpiece is shaped by the holding unit, the shaping is still present at the time of machining. This has the advantage that the machining can be controlled very precisely by the machining unit.

A reference edge can be produced on the workpiece by means of the machining unit, which in particular is designed as a milling cutter. The reference edge can be used as a reference point or reference plane for subsequent machining steps.

According to one embodiment, it is provided that the machining device comprises a control unit configured to output control commands for moving the machining unit based on the detection result of the detection unit. Such a control unit can, for example, be a centralized or decentralized control unit of the machining device.

According to a further embodiment, it is provided that the machining unit can be moved transversely, in particular perpendicular, to the transport direction of the workpiece on the basis of the detection result of the detection unit. This makes it possible to machine a transverse side of the workpiece.

The holding unit may comprise a top pressure belt and/or the conveyor unit may comprise one conveyor line (or several conveyor lines) or one chain track (or several chain tracks). It has been shown that the combination of top pressure belt and conveyor line or chain track is suitable for a particularly secure fixation of the workpiece during its movement with the conveyor unit. A top pressure belt comprises one or more circumferential belts that come into contact with a top side of the workpiece in the vertical direction.

The detection unit can be a camera, in particular a CCD camera. A camera enables the detection of the optical and/or three-dimensional structure so that the data regarding the optical and/or three-dimensional structure acquired by the detection unit can be used in the operation of the machining unit.

The detection unit, in particular the camera, is preferably arranged beneath the workpiece, and the lens of the camera points upwards at least partially in the vertical direction. Thus, a workpiece and a structure present on the workpiece can be detected while the workpiece moves past the camera. The orientation “upwards at least partially in the vertical direction” also includes an oblique orientation of the lens of the detection unit/camera in relation to the vertical direction.

Alternatively, (if the decor side is on top during production) the camera can also be arranged above the workpiece and the camera lens can be arranged downwards in the vertical direction.

In one embodiment, it is provided that the machining device comprises a servo motor or a linear motor to move the machining unit. A servo motor or a linear motor is particularly suited for a more precise positioning of the machining unit. In addition, a servo motor or a linear motor can be driven with an extremely low latency, so that it is possible to carry out a precise machining at high conveying speeds of the workpiece.

The invention further relates to a machining installation, said machining installation comprising a machining device according to one of the preceding aspects. Furthermore, a longitudinal profiling machine arranged downstream of the machining device is provided which is configured to introduce a profile into a narrow side of the workpiece. The longitudinal profiling machine has an alignment ruler to align the workpiece to the narrow side machined by the machining unit. Thus, it is possible to introduce a reference edge into the workpiece by means of the machining device, and said reference edge can be used as a starting point for further machining operations during a machining in the longitudinal profiling machine.

The invention further relates to a method for machining a narrow side of an, in particular a plate-shaped, workpiece. Such a workpiece can be made of wood or wood materials. Within the scope of the method, a machining device or machining installation can be used in accordance with one of the abovementioned aspects.

According to a preferred embodiment, it can be a board made of MDF (medium density fiber material), HDF (high density fiber material), WPC (wood-polymer material), or similar. The method comprises the steps: moving the one workpiece having an optical and/or three-dimensional structure by means of a conveyor unit in a transport direction, detecting the optical and/or three-dimensional structure of the moved workpiece, moving a machining unit for machining a narrow side of a workpiece on the basis of the detection result of the detection unit, with the workpiece being held on the conveyor unit at least between the detection and the machining with the machining unit.

It is preferred that the workpiece, is clamped continuously, particularly by means of a top pressure belt, between the detection and the machining. Thus, the workpiece can be detected and machined in a clamped state.

According to one embodiment of the method, it is provided that a differential edge that is oblique or curved to the transport direction is formed on the workpiece by the machining unit. Thus, the path of the reference edge is independent of the alignment of the workpiece caused by the clamping of the workpiece. If, for example, a workpiece is clamped “at an angle”, the reference edge may have an orientation oblique to the transport direction. Thus, the precision of the machining can be increased and the variability further increased.

In one embodiment, it is provided that the machining device is moved transversely, in particular perpendicular, to the transport direction. This means that it is also possible to machine a transverse side of the workpiece (a side of the workpiece extending transversely to the conveying direction).

By means of the detection unit, a difference between the narrow side of the workpiece and the optical and/or three-dimensional structure can be detected at the front edge of the workpiece, and the deviations between the narrow side of the workpiece and the optical and/or three-dimensional structure detected along the workpiece can be defined as waypoints of the machining unit. This makes it possible to reduce the volume of data transmitted to the machining unit by means of the control commands and to transmit the control commands with a very short time delay.

Furthermore, it can be provided that, after a machining, the workpiece is fed by the machining unit to a longitudinal profiling machine for introducing a profile into a narrow side of the workpiece. Thus, the introduction of a reference edge can be linked with the further machining of the workpiece in the narrow side area. The optical and/or three-dimensional structure of the moved workpiece can be captured with a camera, in particular a CCD camera.

The machining unit can form a flat and/or (continuously profiled reference edge) or a production section on the workpiece.

### BRIEF DESCRIPTION OF THE DRAWINGS

FIG. 1 shows a plan view of an embodiment of the machining device according to the invention.

FIG. 2 is a plan view of a longitudinal profiling machine which can be connected to the machining device according to FIG. 1.

### DETAILED DESCRIPTION OF THE PREFERRED EMBODIMENT

The enclosed figures explain one embodiment of the invention in detail. Modifications of certain features of the described embodiment can be combined with other variants in order to form further embodiments of the invention. Although the embodiment described below is not to be considered restrictive, features can further specify the invention defined in the claims.

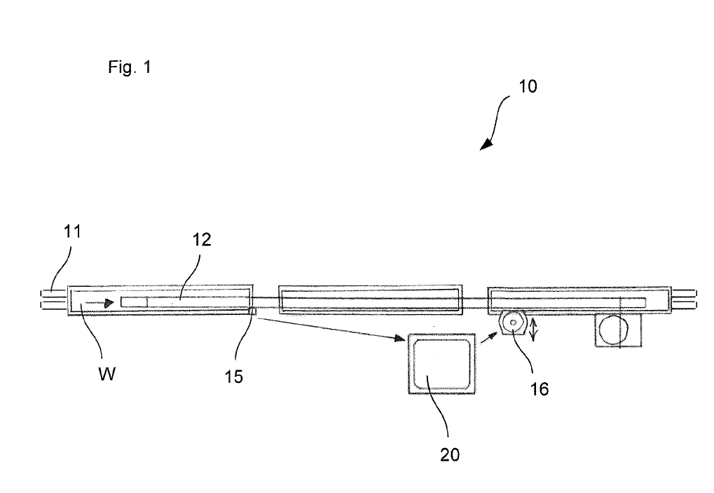

The machining device 10 shown in FIG. 1 for machining a narrow side of a workpiece W is used in the field of the furniture industry to prepare the corresponding workpiece for a further machining. Specifically, such a workpiece may be a floor panel which is provided on one main side with a chamfer extending in the longitudinal direction of the floor panel.

In particular, a reference edge is supposed to be inserted into the respective workpieces W by means of the machining device 10, with the reference edge in turn serving as the reference area for subsequent machining steps.

The machining device 10 comprises a conveyor unit 11, which is presently configured as a belt conveyor. For example, the conveyor unit 11 moves workpieces at a speed of 200 m/min, for example, with the workpieces to be machined, for example, being spaced 50 mm or more from one another. The workpieces W are fed substantially parallel to the transport direction, with the transport direction being indicated in FIG. 1 by a corresponding arrow.

Due to the movement by means of the conveyor unit 11, the workpiece W enters the area of a travelling holding unit 12, which in this example is configured as a top pressure belt. The holding unit 12 makes it possible to keep the workpiece in a clamped state during a continuous movement with the conveyor unit 11.

After the workpiece W has been clamped in this way with the holding unit 12, an optical and/or three-dimensional structure on the main side of the workpiece W (upper side in the plan view according to FIG. 1) can be detected by a detection unit 15 (in particular a CCD camera). According to the embodiment, the detection unit (camera) 15 is arranged beneath the conveyor unit so that the lens of the detection unit 15 faces upwards in the vertical direction. Thus, the decor provided on the underside of the workpiece can be detected with the detection unit 15.

Since the workpiece W is held in a clamped state in the area of the detection unit 15, the position and orientation of the workpiece W and thus of the detected optical and/or three-dimensional structure is also fixed during the conveying movement by the holding unit 12. This means that the clamping of the workpiece can result in a curved, for example s-shaped, contour of the workpiece W.

In a downstream area of the machining device 10 there is a machining unit 16 (in particular a milling cutter) which is arranged to machine the narrow side of the workpiece W and thus to produce a reference edge or a finished cut.

On the basis of the information obtained by the detection unit 15, the position of the machining unit 16 is set by means of a control unit 20. The position of the machining device is guided along a calculated contour, so that the reference edge over the length of the workpiece W. is aligned exactly along an optical structure or a three-dimensional surface structure.

A longitudinal profiling machine 30 is provided in a transport direction downstream of the machining device 10. The workpiece provided with a reference edge by the machining device 10 can, for example, be guided directly from the machining device 10 to the longitudinal profiling machine 30. Alternatively, it is possible to feed the workpiece W to the longitudinal profiling machine 30 via a conveyor section (not shown), or even to store the workpiece W temporarily.

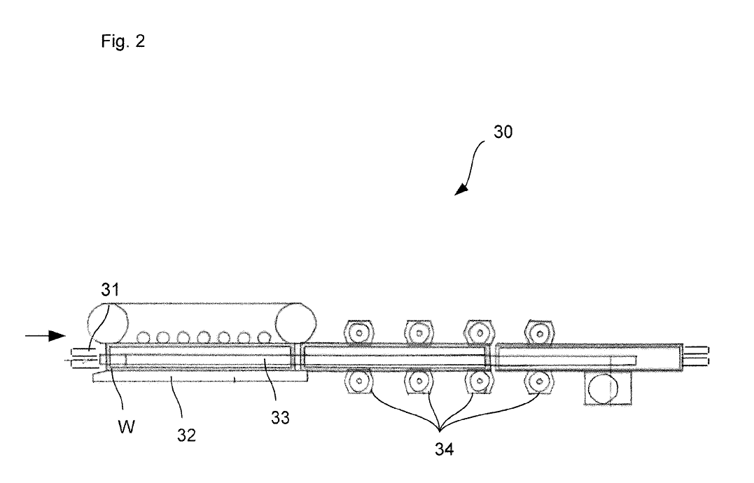

If the workpiece reaches the area of the longitudinal profiling machine 30, the workpiece W is gripped by a conveyor unit 31 of the longitudinal profiling machine 30 and guided in a transport direction (the transport direction is indicated by an arrow in FIG. 2). The longitudinal profiling machine 30 comprises a top pressure 33, which presses the workpiece W against the conveyor unit 31 and thus clamps the moving workpiece.

In the infeed area of the longitudinal profiling machine 30, there is an alignment ruler 32 which serves to align the workpiece W with the reference edge of the workpiece W. Subsequently, the workpiece W is guided through the conveyor device 31 into the area of one or more profiling tools 34, which are used to introduce a profile into a narrow side of the workpiece W. For example, a so-called click profile can be produced in a workpiece if the workpiece W is a floor panel.

In the embodiment example described here, opposing profiling tools 34 are provided in order to provide the respective workpiece W with a profile on both sides.

1. A machining device, comprising:
a machining unit for machining a narrow side of a workpiece;
a conveyor unit for conveying the workpiece in a transport direction relative to the machining unit;
a detection unit for detecting an optical and/or three-dimensional structure of the workpiece moved by means of the conveyor unit; and
a holding unit for holding the workpiece on the conveyor unit at least between the position of the detection unit and the machining unit.

2. The machining device according to claim 1, wherein the machining device comprises a control unit that is configured to output control commands for moving the machining unit on the basis of the detection result of the detection unit.

3. The machining device according to claim 1, wherein the machining unit is movable transversely to the transport direction of the workpiece on the basis of the detection result of the detection unit.

4. The machining device according to claim 3, wherein the machining unit is moved perpendicular to the transport direction of the workpiece.

5. The machining device according to claim 1, wherein the holding unit has a top pressure belt and/or the conveyor unit has a chain track.

6. The machining device according to claim 1, wherein the detection unit comprises a camera.

7. The machining device according to claim 6, wherein the camera is a CCD camera.

8. The machining device according to claim 6, wherein a lens of the camera points upwards in the vertical direction.

9. The machining device according to claim 1, wherein the machining device comprises a servo motor or linear motor to move the machining unit.

10. A machining installation, comprising:
a machining device according to claim 1; and
a longitudinal profiling machine for introducing a profile into a narrow side of the workpiece arranged downstream from the machining device, the longitudinal profiling machine having an alignment ruler to align the workpiece on the narrow side machined by the machining unit.

11. A method for machining a narrow side of a workpiece, comprising the steps:
moving the one workpiece having an optical and/or three-dimensional structure by means of a conveyor device in a transport direction;
detecting the optical and/or three-dimensional structure of the moved workpiece; and
moving a machining unit for machining a narrow side of the workpiece the basis of the detection result,
the workpiece being held on the conveyor device at least between the detection and the machining with the machining unit.

12. The method according to claim 11, wherein the workpiece is plate-shaped.

13. The method according to claim 11, wherein the workpiece comprises wood or wood materials.

14. The method according to claim 11, wherein a reference edge that is oblique or curved to the transport direction is formed on the workpiece by the machining unit.

15. The method according to claim 11, wherein the workpiece is clamped continuously between the detection and the machining.

16. The method according to claim 15, wherein the workpiece is clamped continuously by means of a top pressure belt.

17. The method according to claim 11, wherein the machining unit is moved transversely to the transport direction.

18. The method according to claim 17, wherein the machining unit is moved perpendicular to the transport direction.

19. The method according to claim 11, wherein the detecting unit detects on a front edge of the workpiece a difference between the narrow side of the workpiece and the optical and/or three-dimensional structure and the deviations between the narrow side of the workpiece and the optical and/or three-dimensional structure detected along the workpiece are defined as waypoints of the machining unit.

20. The method according to claim 11, wherein after a machining by means of the machining unit, the workpiece is fed into a longitudinal profiling machine for introducing a profile into a narrow side of the workpiece.

21. The method according claim 11, wherein the optical and/or three-dimensional structure of the moved workpiece is detected by means of a camera.

22. The method according to claim 21, wherein the camera is a CCD camera.

23. The method according to claim 21, wherein a lens of the camera points upwards in the vertical direction.

24. The method according to claim 11, wherein the machining unit forms a flat and/or profiled reference edge or finished cut on the workpiece.
